(19) United States
(12) Patent Application Publication
(10) Pub. No.: US 2006/0155647 A1
(43) Pub. Date: Jul. 13, 2006

(54) Method for distributing information content

(75) Inventors: Maarten Peter Bodlaender, Eindhoven (NL); Robert Jochemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,117

(22) PCT Filed: Nov. 17, 2003
(86) PCT No.: PCT/IB03/05216

§ 371 Date: Jun. 8, 2005

(30) Foreign Application Priority Data
Dec. 13, 2002 (EP) 02080279.9

(51) Int. Cl. G06Q 99/00

(52) U.S. Cl. 705/51

(57) ABSTRACT

A method is disclosed for distributing information content. The content is encoded into a plurality of layers comprising a base layer and an enhancement layer, such that the base layer is needed for reconstructing said information content. The enhancement layer is transmitted by means of superdistribution. Optionally, an accessible sample of the base layer can also be provided. When receiving the layer(s) users will become interested in purchasing the content Thus, according to the method a request for purchase is received from a user, and upon such a request the base layer is transmitted to the user. Not until the user holds both the base layer and the enhancement layer the content can be satisfactorily used. A system, a server, and a computer program product, providing corresponding distribution capabilities are also disclosed.

The present invention generally relates to a method for distributing information content.

For a content vendor selling information content, such as music, video, software, or the like, which is present in a digital format, many different distribution options are available. Examples thereof are distribution by means of physical media, such as CDs, DVDs, etc., and distribution via networks, such as LANs, Internet, etc. On one hand it is desirable to reach as many potential customers as possible in a way that is as simple as possible. On the other hand there is a problem of unauthorized use of the content. One interesting option of distribution is superdistribution.

Superdistribution is a method for distributing information content, which method is developed by Ryoichi Mori and Masaji Kawahara. The idea of superdistribution is that the information content is made available freely and without restriction but is protected from modifications and modes of usage not authorized by its vendor. The information content is distributed over public channels in encrypted form. In order to participate in superdistribution a computer must be equipped with a special hardware unit, which preserves secret information such as a deciphering key and manages the proprietary aspects of the superdistribution system. When a person who has received the information content would like to use the content a low bandwidth connection between the user's computer and a system server is established, a purchase is logged, and the deciphering key is retrieved by means of the hardware unit.

Nothing prevents the receiver of the encrypted information content to pass it on to other persons. On the contrary, that is a basic idea of the superdistribution concept, i.e. that the content vendor effortlessly will obtain a helping hand in the distribution process. Thereby, the content vendor, by means of a very limited initial effort and cost, will reach a large number of potential customers.

The information content could be any digital content, which is distributable over the Internet, on CDs, on DVDs, etc., although computer software, music, videos and games are typical examples. Thus, content can be easily and freely distributed, but the use of the content is subject to a fee, and involves a decryption operation.

However, this superdistribution has a weak link in that the access to the content relies on a cryptographic protection. If a hacker would manage to crack the cryptographic protection the content would lay open to the world. Assume for example that a vendor distributes 10000 encrypted songs/video titles. Then, assume that the crack is also broadly distributed over the Internet. It would be devastating for the vendor. This is a main drawback that prevents the superdistribution method from being accepted among the major content vendors throughout the world.

An object of the invention is to achieve a distribution of information content, which preserves the advantages of superdistribution but increases the level of distribution security.

The object is achieved by a method for distributing information content according to claim 1.

Thus, according to a first aspect of the invention, there is provided a method for distributing information content encoded as a plurality of layers comprising a base layer and an enhancement layer, such that the base layer is needed for reconstructing said information content. Such an encoding is generally called multi-layered encoding, which will be further described below. Further, the enhancement layer is transmitted by means of superdistribution. Superdistribution has been explained above. Thus, an enhancement layer is distributed to a plurality of potential customers, or users, by means of any suitable media, such as CDs, DVDs, hardware devices, and bitstreams in a network. The users are free to copy and/or pass on the enhancement layer to anybody.

The method further involves the step of receiving a request for purchase, regarding at least a portion of the information content. The request is received from a user. This occurs when a user has caught an interest in using the information content. The method further involves the step of transmitting at least a portion of the base layer corresponding to said request to the user. Thus, in response to the request the base layer, or at least a portion thereof, is transmitted to the user. Since, initially, the user has only received one or more enhancement layers, the content is not useable. To actually use the content, the base layer is also required. Depending of the type of information content it is likely that the user wishes to purchase all of the information content or a part thereof. Assume, as an example, that the information content comprises music, where a large number, such as thousands, of songs are available for purchase. Then, typically, the user will be interested in a mere fraction, or piece, such as an item, of the full information content. Consequently, only the corresponding portion of the base layer can or will be transmitted to the user. Assume, as another example, that the information content is a single software product. Then the only option available is to transmit the whole base layer.

In accordance with an embodiment of the method the step of receiving a request comprises the steps of establishing a connection between the user and a server, and receiving said request at said server via said connection. While the initial superdistribution, as well as the following steps for providing the user with the base layer could in principle, and in a widest sense of this invention, be made by means of any one of several different distribution media, it is an advantage to use computer communication, involving a server, for handling the purchase operation. The same is true for the embodiment as defined in claim 3, wherein the step of transmitting at least a portion of the base layer comprises the steps of detecting the reception of said request; determining what specific information content the user requests to purchase; and transmitting a base layer associated with said specific information content from the server to the user. According to an embodiment of the method, it comprises the further step of encrypting the enhancement layer before transmitting the same by means of superdistribution. This step is advantageous in that it adds a level of security to the already high level, which is obtained through the present invention. The same is true for the embodiment as defined in claim 5, wherein the method comprises the further step of encrypting said at least a portion of the base layer before transmitting the same.

According to an embodiment of the method, the steps are performed over the Internet. The advantage of this embodiment is the world wide use of Internet, and the huge amount of connected users, who are potential customers.

The object is also achieved by a computer program product according to claim 9.

Thus, according to a second aspect of the invention there is provided a computer program product comprising a computer readable medium storing computer executable instructions for causing a computer to distribute information content encoded as a plurality of layers, which comprise a base layer and an enhancement layer, wherein the base layer is needed for reconstructing said information content. The computer executable instructions, when run on a computer, causes the computer to perform the steps of transmitting said enhancement layer by means of superdistribution; receiving a request for purchase from a user; and transmitting at least a portion of said base layer corresponding to said request to said user.

By computer readable medium is meant any medium that can store, i.e. hold data which are computer readable. Such a medium can be a physical memory means, such as a CD-ROM, a diskette, a hard disk, etc., as well as a data signal carrying the data embodying the computer executable instructions.

The object is also achieved by a system according to claim 10. Thus, according to a third aspect of the invention there is provided a system, which is arranged for distributing information content encoded as a plurality of layers comprising a base layer and an enhancement layer, such that the base layer is needed for reconstructing said information content. The system comprises means for handling said information content; a first server and a second server. The first server comprises means for transmitting said enhancement layer by means of superdistribution. The second server comprises means for receiving a request for purchase, regarding at least a portion of said information content, from a user; and means for, in response to receiving the request, transmitting at least a portion of said base layer corresponding to said request to said user.

Further, according to a fourth aspect of the invention, as defined in claim 14, there is provided a server for use in such a system. The server comprises means for transmitting an enhancement layer by means of superdistribution.

According to a fifth aspect of the invention, as defined in claim 15, there is provided a server for use in such a system. The server comprises means for receiving a request for purchase, regarding at least a portion of an information content, from a user; and means for, in response to receiving the request, transmitting at least a portion of a base layer corresponding to said request to said user.

It is to be noted that according to embodiments of the system, the first and second servers of the system can be implemented either as two individual servers, or as a single server device. In other words, the very implementation allows for a single server comprising all means, and for two separate servers according to the forth and the fifth aspect, respectively.

The object is also achieved by a client system according to claim 16.

Thus, according to a sixth aspect of the invention there is provided a client system which is arranged for processing information content encoded as a plurality of layers comprising a base layer and an enhancement layer, such that the base layer is needed for reconstructing said information content. The client system comprises means for receiving said enhancement layer; means for transmitting a request for purchase, regarding at least a portion of the information content, to an information content vendor; means for receiving at least a portion of said base layer corresponding to said request; and means for presenting said information content to a user by processing said at least a portion of said base layer and a corresponding portion of said enhancement layer.

According to an embodiment of the client system said means for presenting said information content to a user comprises means for decoding said layers.

It is to be noted that the key for performing the decoding operation is received by the client system in conjunction with the base layer. Thus, said means for decoding the layers is arranged to handle such a key. The very multi-layer encoding/decoding operations and the keys involved are known as such. In one view, the base layer as such can be regarded, or used, as a key. Then no separate key is used, but when the base layer is applied in a predetermined way to the enhancement layer their total content is accessible. In other words, the key is inherent in the base layer.

The object is also achieved by a computer program product according to claim 18.

Thus, according to a seventh aspect of the invention there is provided a computer program product comprising a computer readable medium storing computer executable instructions for causing a computer to process information content encoded as a plurality of layers, which comprise a base layer and an enhancement layer, wherein the base layer is needed for reconstructing said information content. The computer executable instructions, when run on a computer, causes the computer to perform the steps of receiving said enhancement layer; transmitting a request for purchase to an information content vendor; receiving at least a portion of said base layer corresponding to said request; and presenting said information content to a user by processing said at least a portion of said base layer and a corresponding portion of said enhancement layer.

Thus, in accordance with the present invention the technique for superdistributing information content is combined with the technique for splitting the content into different layers. The known use of multi-layered encoding is to facilitate simultaneous multicast of information content, typically video, to many users over a network, where the available bandwidth varies throughout the network. The content is split into several so called layers, typically data streams, comprising a base layer and one or more enhancement layers. The base layer contains a large enough part of the content (video) so as to be sufficient for a low-quality, but still useable (viewable), result when accessed by the user. The advantage of transmitting merely the base layer is that the bandwidth requirement is modest. Each enhancement layer adds quality, while demanding more bandwidth. Thus, the number of layers transmitted to a specific user, or group of users, can be adjusted in accordance with the available bandwidth.

In accordance with this invention this multi-layer concept is in a sense inverted, since the first layer transmitted is not the base layer, but an enhancement layer, while the base layer is transmitted later. In addition to that, as explained above, the multi-layer concept is combined with the superdistribution concept to an advantageous whole. Thereby, at least a part of the content can be widely and freely distributed, while the problem of hackers described above is eliminated. It is to be noted that base layers for this invention can be of a lower quality, and hence use less bandwidth, than the base layers that are used in the typical use of multi-layered encoding.

These and other aspects of the invention will be apparent from and elucidated with reference to the embodiments described hereinafter.

The present invention will be described in greater detail with reference made to the accompanying drawings, in which:

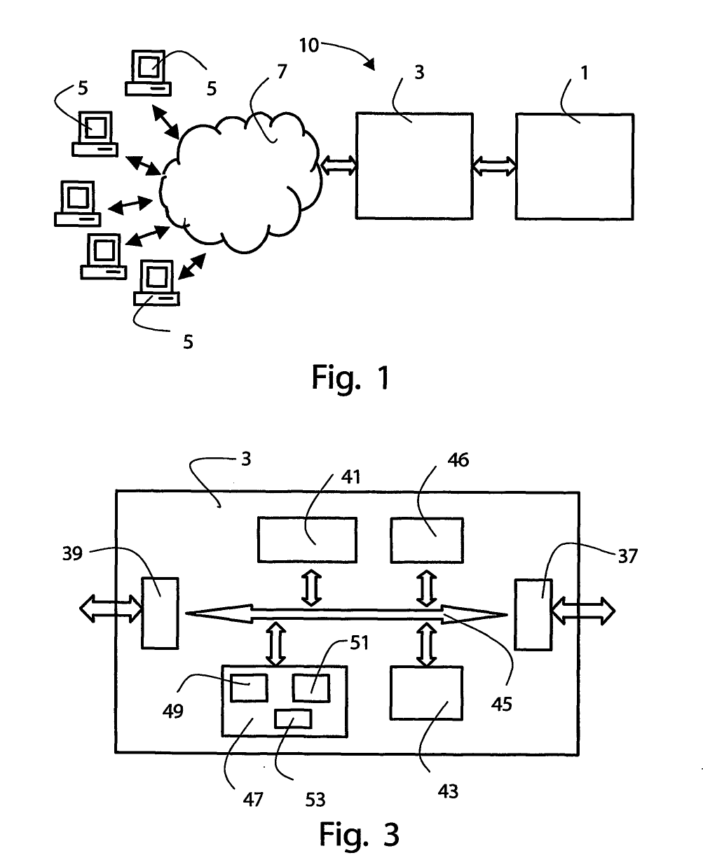

FIG. 1 schematically shows an embodiment of a computer communication system for performing an embodiment of the method according to this invention;

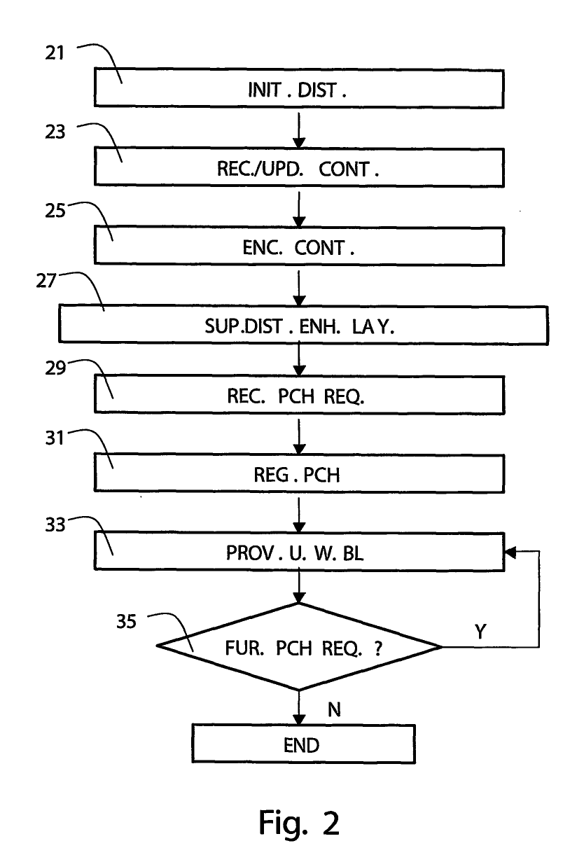

FIG. 2 is a flowchart for an embodiment of the method according to the present invention;

FIG. 3 schematically shows an embodiment of a server according to the present invention;

FIG. 4 schematically shows an embodiment of a client system according to the present invention; and

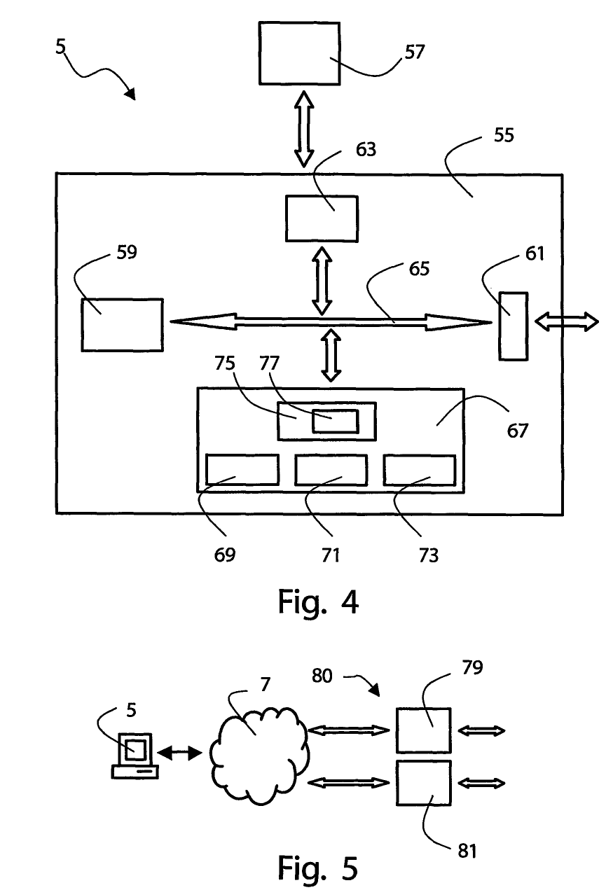

FIG. 5 schematically shows another embodiment of a computer communication system according to this invention.

The method for distributing information content, below simply content, is preferably performed in a computer communication system. In one embodiment thereof the computer system 10 comprises a Content Vendor System 1, connected to a Content Handling Server 3, which in turn is connected to the Internet 7. The Content Vendor System 1 and the Server 3, in this embodiment, are the hardware units that handle the operation of providing a specific content to an amount of users and billing them for the use of the content. A number of users, illustrated by Client Systems, 5 are also connected to the Internet 7, and are thus potential customers to the Content Vendor.

The server 3 can be any suitable device which is arranged for server purposes. One example of a server embodiment is shown in FIG. 3. The server 3 comprises a first I/O unit 37, which is externally connected to the Content Vendor System 1, a second I/O unit 39, which is externally connected to the Internet 7, a processor 41, and a data memory unit 43. All circuits are internally connected to an internal bus 45. The server 3 further comprises means 46 for handling the content. The server 3 further comprises a communication control means 47 for controlling the external communication, which is also connected to the internal bus 45. The communication control means 47 comprises means 49 for transmitting enhancement layers by means of superdistribution, means 51 for transmitting base layers, and means 53 for receiving and handling a request for purchase from a user 5.

The client system 5 can be any suitable type of system that can be used by a user for processing the information content. In an embodiment of the client server system, as shown in FIG. 4, the system comprises a computer 55 and a display screen 57. Typically, the system is a PC (Personal Computer). The computer 55 comprises a processor 59, an I/O unit 61, and a data memory unit 63, which are interconnected via an internal bus 65. The I/O unit 61 is externally connected to the Internet 7. The client system 5 further comprises a communication control means 67 for controlling the external communication, which is also connected to the internal bus 65. The communication control means 67 comprises means 69 for receiving enhancement layers, means 71 for transmitting a request for purchase from the user 5 to the content vendor, i.e. to the Content Vendor System 1, and means 73 for receiving base layers. Further, the communication control means 67 comprises means 75 for presentation of content, which means 75, in turn, comprises a decoder 77 for decoding the enhancement and base layers.

In accordance with an embodiment of the method and as shown in FIG. 2, the method is performed as follows. A content distribution is initiated by the Content Vendor (box 21). Assume, for the purposes of this description, that the content is music. The Server 3 receives the music file from the Content Vendor System 1 (box 23) via the first I/O unit 37, and stores the file in the data memory unit 43. Alternatively the file is an updating file, which merely contains changes in relation to a previous version of the file. The music file may contain a large number of songs and/or albums. The Content Vendor System 1 splits the music by encoding it into a base layer and an enhancement layer (box 25), before feeding the contents to the Server 3. As an alternative, more than one enhancement layer can be generated. Further, alternatively, the encoding of the layers can be performed by the Server 3, and more precisely by the means 46 for handling information content. Otherwise, the task for the information content handling means 46 is to receive the encoded content and provide the correct layers to the different means 49, 51 for transmitting the different layers.

Then the enhancement layer is superdistributed by the Server 3, using said means 49 for enhancement layer transmissions (box 27). This means that the enhancement layer is distributed over the Internet, or the like, to a large number of users 5, who have the specific functionality for superdistribution installed in their Client Systems 5, which typically are Internet connected computers. The functionality includes computer hardware and instructions for revenue-collection and tracking of usage of the content. When the content is music, video or the like it is likely to be paid for once. On the other hand, in case the content would be for instance a computer program, the functionality may be arranged for monthly billing of the user 5 in relation to the amount of usage, etc. Thus, the client system 5 receives the enhancement layer at the I/O unit 61, which passes it on to the means 69 for receiving enhancement layers in the communication control means 67.

In line with the concept of superdistribution, the enhancement layer can be further distributed by the users, which then, in turn, can use any kind of communication media.

The non-usable superdistributed enhancement layer is accompanied by usable information. The usable information contains information on where to obtain the base layer, and information about the content, i.e. information about what can actually be bought. This information is presented to the user by means of the means 75 for presentation of content.

If the user 5 wants to purchase a piece of content, which in the present example can be one or more individual songs, and/or one or more albums, he will then make a request to purchase that specific content, i.e. a request to receive the corresponding base layer, to the Content Vendor selling the music file. This request is generated and transmitted to the server 3 by the means 71 for transmitting a request for purchase. The request contains sufficient user information, such as name, addresses, credit card number, etc., to complete the purchase. This purchase request is received by the Server 3 (box 29). The Server 3, using the means 53 for receiving and handling the user information, then processes the user information (box 31) in order to be able to return the base layer and to be able to bill the user 5 for the requested music. Alternatively, this step may involve the Content Vendor System 1 for processing the user information.

In a next step the Server 3, using said means 51 for transmitting base layers, transmits the base layer associated with the chosen piece of content to the client system 5 of the user (box 33). Typically, when it comes to music, video, or the like, the transmitted base layer constitutes a portion of the whole base layer, but it could be the whole base layer as well. The steps of handling and responding to the purchase request, i.e. the steps defined in the boxes 29-33 will be performed for every user 5 who wants to make a purchase (box 35).

Finally the client system 5 receives the base layer, or the portion thereof, and reconstructs the content by decoding the layers such that the content can be played back by the client system 5. Thus, the base layer is received at the client system 5 by means of the means 73 for receiving base layers, and then the means 75 for presentation of content decodes the base and enhancement layers and presents the result to the user. A decoding key is provided in conjunction with the base layer in a known manner, which is understood by a man skilled in the art and will not be further explained. It is understood, at least by a man skilled in the art, that the base layer, at the user end, is handled in a way that does not create any decoded file that is easy to copy. The content is, for example, only decoded when played back. The skilled man will be able to determine which known method that is applicable.

The means for performing the method steps described above, which are comprised in the server, are possible to implement either in hardware or in software. Consequently, an aspect of the present invention, is to provide a computer program product comprising a computer readable medium storing computer executable instructions for causing the server to distribute information content in accordance to the above-described embodiment and other embodiments of the method according to this invention.

Similarly, in accordance with this invention, there is provided a computer program product comprising a computer readable medium storing computer executable instructions for causing the client system to process information content in line with the above-described and other embodiments of the method. Thus, the means embodied in the client system, for performing the method, are implementable in hardware or software.

In an alternative embodiment of the computer communication system 80 for distributing information content in accordance with the present invention it comprises a first and a second server as follows.

The first server 79 is arranged to perform a first part of the method, i.e. the distribution of the enhancement layer. For that matter, and according to this embodiment, the first server 79 comprises the same means as the server 3 shown in FIG. 3, except for the means 51 for transmitting base layers, and the means 53 for receiving and handling a request for purchase from a user 5.

The second server 81 comprises the same means as the server 3 shown in FIG. 3, except for the means 49 for transmitting enhancement layers by means of superdistribution.

Consequently, in accordance with this alternative embodiment of the distribution system 80, the work of performing the distribution is divided between the first and second servers 79, 81. The first and second servers can either both be connected to the Content Vendor System 1, or be connected to different sources for acquiring the information content, or an appropriate portion thereof.

In alternative embodiments, within the scope of the invention, rather than superdistributing the enhancement layer over the Internet via a server, it is superdistributed on a physical medium like a CD/DVD/Hard-disk/solid state memory. As regards the alternatives of hard-disk, solid state memory, and other hardware devices with storage capability, the enhancement layer might already be stored in the device on the purchase thereof.

In a further alternative embodiment the content information comprised in the enhancement layer is not only song titles but also short samples of the songs. This requires that a portion of the base layer is co-distributed with the enhancement layer. Such samples can be provided for other types of content.

The basic division of the content is two layers, the base layer and one enhancement layer. However, within the scope of this invention the content can be divided into more layers, if desired. Still, only upon a request for purchase the content at the user-end will be completed to such an extent that it is useable at an enjoyable level. Generally, the enhancement layer is not useful at all without the base layer.

When the content is split into the base layer and the enhancement layer, the relative size of the base layer can be set as desired. On one hand the base layer should be as small as possible in order to be quickly communicated, and on the other hand it should be as large as possible in order to make it more difficult to illegally distribute base layer encodings. In practise the base layer should be relatively small to ensure that a user is able to quickly download it when the user purchases the content, or a piece of the content such as the song. However, as technology makes progress, the base layer can be made larger. The division could for example be made such that part of the communication between the Server 3 and the Client Systems 5 can take place on always-on low-bandwidth channels and part thereof will take place on sometimes-on high-bandwidth channels.

In other embodiments of the method one of or both the base layer and the enhancement layer are encrypted. Any known encryption method that is applicable can be used. Since such encryption methods are well known to a man skilled in the art they will not be further explained here. An example of an encryption method is Elliptic Curve Cryptography.

1. A method for distributing information content encoded as a plurality of layers comprising a base layer and an enhancement layer, such that the base layer is needed for reconstructing said information content, characterised by the steps of:
transmitting said enhancement layer by means of superdistribution;
receiving a request for purchase, regarding at least a portion of said information content, from a user; and
in response to receiving the request, transmitting at least a portion of said base layer corresponding to said request to said user.

2. The method according to claim 1, wherein said step of receiving a request comprises the steps of:
establishing a connection between the user and a server; and
receiving said request at said server via said connection.

3. The method according to claim 2, wherein said step of transmitting at least a portion of said base layer comprises the steps of:
detecting the reception of said request;
determining what specific information content the user requests to purchase; and
transmitting a base layer associated with said specific information content from the server to the user.

4. The method according to claim 1, further comprising the step of:
encrypting said enhancement layer before transmitting the same by means of superdistribution.

5. The method according to claim 1, further comprising the step of encrypting said at least a portion of the base layer before transmitting the same.

6. The method according to claim 4, further comprising the step of providing the user with a key for decrypting said encrypted layer.

7. The method according to claim 1, wherein the steps are performed over the Internet.

8. The method according to claim 1, wherein a portion of the base layer is co-distributed with said enhancement layer.

9. A computer program product comprising a computer readable medium storing computer executable instructions for causing a computer to distribute information content encoded as a plurality of layers, which comprise a base layer and an enhancement layer, wherein the base layer is needed for reconstructing said information content, charactereised in that said computer executable instructions when run on a computer causes the computer to perform the steps of:
transmitting said enhancement layer by means of superdistribution;
receiving a request for purchase, regarding at least a portion of said information content, from a user; and
in response to receiving the request, transmitting at least a portion of said base layer corresponding to said request to said user.

10. A system which is arranged for distributing information content encoded as a plurality of layers comprising a base layer and an enhancement layer, such that the base layer is needed for reconstructing said information content, characterised in that it comprises:
means for handling said information content;
a first server having means for transmitting said enhancement layer by means of superdistribution; and
a second server having means for receiving a request for purchase, regarding at least a portion of said information content, from a user; and means for, in response to receiving the request, transmitting at least a portion of said base layer corresponding to said request to said user.

11. The system according to claim 10, wherein said first and second servers are embodied by a single server device

12. The system according to claim 10, wherein said means for handling the information content are arranged to encode the information content into said plurality of layers.

13. The system according to claim 10, wherein said means for handling the information content are arranged for receiving the information content encoded as said plurality of layers.

14. A server for use in a system according to claim 10, the server comprising means for transmitting an enhancement layer by means of superdistribution.

15. A server for use in a system as claimed in claim 10, the server comprising means for receiving a request for purchase, regarding at least a portion of an information content, from a user; and means for, in response to receiving the request, transmitting at least a portion of a base layer corresponding to said request to said user.

16. A client system which is arranged for processing information content encoded as a plurality of layers comprising a base layer and an enhancement layer, such that the base layer is needed for reconstructing said information content, characterised in that it comprises:
means for receiving said enhancement layer;
means for transmitting a request for purchase, regarding at least a portion of said information content, to an information content vendor;
means for receiving at least a portion of said base layer corresponding to said request; and
means for presenting said information content to a user by processing said at least a portion of said base layer and a corresponding portion of said enhancement layer.

17. The client system according to claim 16, wherein said means for presenting said information content to a user comprises means for decoding said layers.

18. A computer program product comprising a computer readable medium storing computer executable instructions for causing a computer to process information content encoded as a plurality of layers, which comprise a base layer and an enhancement layer, wherein the base layer is needed for reconstructing said information content, characterised in that said computer executable instructions when run on a computer causes the computer to perform the steps of:
receiving said enhancement layer;
transmitting a request for purchase to an information content vendor;
receiving at least a portion of said base layer corresponding to said request; and
presenting said information content to a user by processing said at least a portion of said base layer and a corresponding portion of said enhancement layer.
